(19) United States
(12) Patent Application Publication
(10) Pub. No.: US 2016/0101539 A1
(43) Pub. Date: Apr. 14, 2016

(54) METHOD FOR PRODUCING BOG (BLACK) OAK WOOD

(71) Applicant: UAB "GRIGO", Kaunas (LT)

(72) Inventor: Vytautas Grigas, Garliava (LT)

(73) Assignee: UAB "GRIGO", Kaunas (LT)

(21) Appl. No.: 14/893,654

(22) PCT Filed: May 23, 2014
(86) PCT No.: PCT/IB2014/061670

§ 371 Date: Nov. 24, 2015

(30) Foreign Application Priority Data
May 24, 2013 (LT) 2013 052

(51) Int. Cl. B27K 5/02; B27K 3/08; B27K 3/26

(52) U.S. Cl. CPC B27K 5/02; B27K 3/26; B27K 3/08; B27K 2240/50

(57) ABSTRACT

The present invention implements a method to produce stained oak, having features identical or very close to a bog (black) oak wood found in wetlands. This method is based on the reaction of iron with the tannin present in the wood, and it comprises the following steps: placing the wood blank into a metal container; filling the container with water (or other suitable solvent), so that all the blanks are submersed; blending iron oxide into the solvent and producing the solution of iron oxide of a suitable concentration; heating the container to the desired temperature between 60 to 100 degrees Celsius; maintaining the temperature of the container for a certain period of time, depending on the dimensions of the blanks; compensating the water that was lost during the process due to evaporation by adding an additional amount of water; after the determined period of time or when the desired shade of wood (black, gray, blue, purple, or brown) is achieved and/or the desired density is reached; stopping the heating process and discharging the water from the tank; washing the blanks; drying the blanks in sawdust or using other desiccation means; and/or drying the blanks in convection or vacuum dryer, or using other similar means, until a needed moisture content is reached.

### FIELD OF INVENTION

This invention relates to methods of changing wood properties, in particular with techniques to modify oak wood, providing the qualities of bog (black) oak wood found in wetlands.

### BACKGROUND OF INVENTION

Bog (black) oak wood (not to be confused with Quercus velutina) is a type of wood to which the oak wood fossils are usually attributed, i.e., fallen oak trees (bog oak) of an early stage of fossilization that are found in wetlands. In nature, bog (black) oak wood is formed, when fallen oak trees are preserved in wetlands, due to spending an extended amount of time in anaerobic environmental conditions, in the environment saturated with tannic acid (tannins) and other materials. The period during which the wood under such conditions assumes the characteristic color and qualities may vary from a few hundred to a few thousand years. Furthermore, it is never known exactly where to find this kind of fossil trees, because they are usually buried under the soil surface.

For these reasons, and also because bog (black) oak wood is more rigid and more resistant to environmental impact and has decorative qualities, this type of wood is very rare and expensive. Various methods taking advantage of technological developments were proposed for producing wood that has characteristics comparable to those of bog oak wood—a similar or identical wood color.

U.S. Patent application No. US2002178608, published on 2002-12-05, describes a device and a method for producing wood identical to a bog (black) oak wood found in wetlands. This method consists of several basic steps: loading the timber into the reactor; capsulizing the reactor; vacuumizing the reactor; blowing ammonia into the timber filled reactor; decreasing the temperature (and pressure) in the reactor; hydrothermal processing of the timber in the reactor; and removal of the finished timber that has similar qualities to bog (black) oak wood. The described process should last less than one hundred twenty hours, which is much shorter than the natural process lasting thousands of years.

British patent No. GB152427, published on 1920-10-14, describes a method of processing wood to modify the color into grey or black by employing iron and tannin solutions. The wood is immersed in the above-described solutions for several times and then dried. Ultimately the wood is treated with ammonia or other alkali. Color modification may also be accomplished by replacing tannin or the like by logwood (Haematox Campechianum) extract. Impregnation can be performed using vacuum or increased pressure, low or high temperature.

Earlier inventions describe solutions for wood blackening (ebonizing wood) where various chemical compounds are used and hermetical reactors are needed. The use of additional chemicals may potentially be harmful to the environment and for people that are using wood-based products.

In addition to this, many inventions employ the use of such materials as ammonia (the use is described the above-cited U.S. application No. US2002178608). While treatment with ammonia enables modifying wood color in entire volume, the use of it may cause environmental problems, and the achieved wood color change is limited with brown shades of various intensity. Another major drawback of usage of ammonia is that it reduces the density of the wood.

There's another substance (group of materials), used in oak blackening process—and that is tannic acid. This acid is one of the agents needed to create a color modification. This material is relatively costly, therefore the use of it for preparing wood soaking solution is considered to be a disadvantage.

Other disadvantage of the aforementioned inventions is that a special reactor, i.e. controlled environmental conditions may be needed to achieve the results, and this increases the costs and impedes the implementation of this solution.

### SUMMARY

To eliminate these shortcomings, the present invention proposes a method of processing oak wood, providing it a color modification (black, gray, blue, purple, or brown hues and combinations thereof are possible), an increase in the density and alternation of other properties.

The method comprises these steps: placing the wood blank into a metal container; filling the container with water (or other suitable solvent), so that all the blanks are submersed; blending iron oxide mixture into the solvent and producing the solution of iron oxide of a suitable concentration; heating the container with the solution to the desired temperature, usually between 60 to 100 degrees Celsius; maintaining the temperature of the container and the solution for a certain period of time, depending on the dimensions of the blanks; compensating the water that was lost during the process due to evaporation by adding an additional amount of water; after the determined period of time or when the desired shade of wood (black, gray, blue, purple, or brown) is achieved and/or the desired density is reached, stopping the heating process and discharging the water from the tank; washing the blanks; drying the blanks in sawdust or using other means; drying the blanks in convection or vacuum dryer, or using other similar means.

Wood assumes these qualities when iron oxide reacts with the tannins (tannic acid) in the wood. The reaction is faster at higher temperatures.

Other features and advantages of the invention will be better understood by reading the options of the preferred embodiments, and by taking into the account the enclosed drawings.

### DESCRIPTION OF DRAWINGS

For a better understanding of the invention and its practical applications, the following explanatory drawings are included. The drawings are only provided as examples and in no way limit the scope of the invention.

FIG. 1 represents the general scheme of the most preferred embodiment, comprising the container, the heating element and the solution.

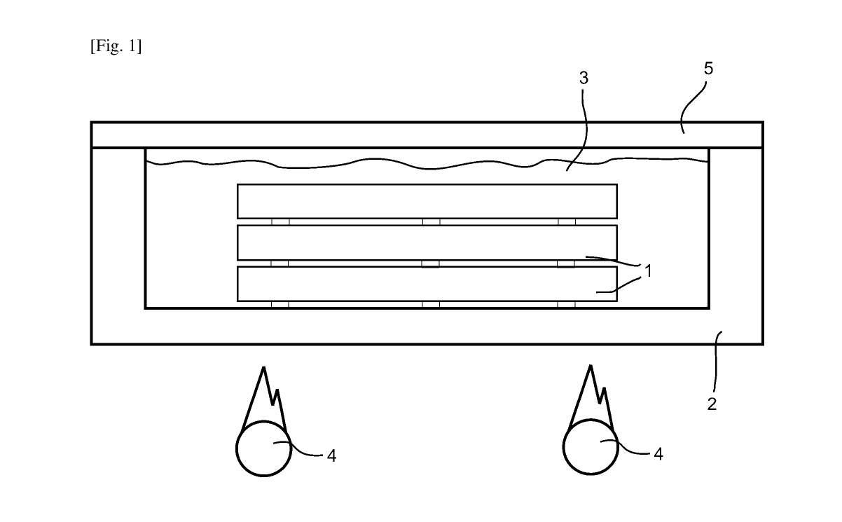

### DETAILED DESCRIPTION OF PREFERRED EMBODIMENTS

The present invention is to create a method to change wood properties. Specifically, it is aimed at establishing a production method in which the common oak wood is endued with the qualities of the bog oak wood.

In the preferred embodiment, the wood to be processed is that of pedunculate oak (Quercus robur). Blanks (1) that are produced of this wood or from the wood with similar properties are placed in the container (2), preferably made of metal, and poured over with solvent, preferably water. It should be obvious that the blanks may be of any geometric shape, but one can choose the size of the blanks so that during the processing the solution would easily penetrate through the entire volume of wood, and so that the highest amount of the blanks could be placed in the container (2) in one load. The amount of the solvent should be sufficient to cover all pieces of wood. In order to keep the blanks completely under water to avoid free-floating in the solvent, additional measures can be used (not shown in the drawings), such as belts or weights. A mixture of iron oxides (common rust may be used) is admixed into the solvent, thus forming water—iron oxide solution (3). Preferably the concentration of the solution is 0.14 per cent of iron oxide. The container is heated up until it reaches 60 to 100 degrees Celsius temperature at which the reaction begins between the tannic acid in the wood and iron oxides, using any suitable heating means, such as electric heating elements, fuel combustion (4) or others. When the required temperature of the container and the solution is reached, it is kept even for some time. The water that was lost during the process due to evaporation is compensated by constantly adding an additional amount of solvent. After the determined period of time, or when the intended properties of wood are obtained, the heating is stopped and the water is discharged from the container. Blanks are washed, preferably with water. Afterwards the blanks having 50-80 percent moisture content are dried in sawdust until they reach about 30 percent moisture content. Then the blanks are further dried in convection or vacuum dryer until they reach 6-8 percent moisture content.

In another preferred embodiment, the wood treatment process is accelerated by using a sealed container (e.g., with a sealable lid (5)), where vacuum is made before adding the water solution (not shown in the drawings). The aim is to remove moisture and air from the wood. This step is carried out before adding iron oxide solution to the container.

In another preferred embodiment, the wood treatment process is accelerated by using the aforementioned closed container, in which an increased pressure is created.

The increased pressure may be formed in a sealed container by increasing the temperature or by using a compressor (not shown in the drawings).

The usage of pressure, vacuum, or alternation of these processes enables one to achieve substantially improved absorption of the solvent by wood fibers. Hereby the process can be accelerated. Vacuum opens microscopic cavities in wood, and this facilitates air extraction from the wood. Subsequently, by increasing the pressure and submersing the wood blanks into the solvent, the infiltration of the solvent into wood can be improved, thus providing much better interaction across all the wood piece volume.

In other embodiments a different type of wood may be used (it is important that the wood would have a high amount of natural tannins), another form of wood blanks (1), and different concentrations of solutions, unmixed solutions of certain kinds of iron oxide or specific iron oxide mixtures may be used. The obtained color and its intensity depends on iron oxide (FeO, FeO •Fe₂O₃, Fe₂O₃) ratios and concentrations in the solution. It is also possible to use other equivalent means of drying or multi-cycle drying and soaking the wood in the aforementioned solution.

1. A method of producing wood having properties similar to bog oak wood, the method comprising:
a) immersing a piece of wood in a solution comprising iron oxide and a solvent;
b) retaining the piece of wood immersed in the solution, at a temperature between 60 and 100° C., until a moisture content of 50-80 percent in the piece of wood of is achieved;
c) washing the piece of wood with water, after the piece of wood has been immersed in and processed with the solution; and
d) drying the piece of wood after washing.

2. The method according to claim 1, wherein the drying the piece of wood after washing comprises drying the piece of wood in sawdust until a 30 percent moisture content in the piece of wood is reached, and drying the piece of wood in at least one of a convection dryer and a vacuum dryer until a 6-8 percent moisture content is achieved in the piece of wood.

3. The method according to claim 1, further comprising pre-processing the piece of wood in a vacuum environment before immersing the piece of wood with the solution to remove moisture and air from the piece of wood.

4. The method of claim 1, wherein the solvent comprises water.

5. The method of claim 1, wherein the iron oxide comprises a mixture of at least two of FeO, FeO •Fe₂O₃, and Fe₂O₃.

6. The method of claim 1, wherein the immersing the piece of wood in the solution comprises, exposing the piece of wood to a pressure higher than that of a surrounding atmospheric pressure.

7. The method of claim 1, wherein the immersing the piece of wood in the solution comprises, exposing the piece of wood to a pressure lower than that of a surrounding atmospheric pressure.

8. The method of claim 1, wherein the piece of wood comprises a piece of pedunculated oak.

9. A method of producing wood having properties similar to bog oak wood, the method comprising:
a) exposing a piece of wood to a solution comprising iron oxide and a solvent;
b) retaining the piece of wood in contact with the solution, at a temperature between 60 and 100° C., until a moisture content of 50-80 percent in the piece of wood of is achieved;
c) washing the piece of wood with water, after the piece of wood has been exposed to and processed with the solution; and
d) drying the piece of wood after washing.

10. The method according to claim 9, wherein the drying the piece of wood after washing comprises drying the piece of wood in sawdust until a 30 percent moisture content in the piece of wood is reached, and drying the piece of wood in at least one of a convection dryer and a vacuum dryer until a 6-8 percent moisture content is achieved in the piece of wood.

11. The method according to claim 9, further comprising pre-processing the piece of wood in a vacuum environment before exposing the piece of wood to the solution to remove moisture and air from the wood.

12. The method of claim 9, wherein the solvent comprises water.

13. The method of claim 9, wherein the iron oxide comprises a mixture of at least two of FeO, FeO •Fe₂O₃, and Fe₂O₃.

14. The method of claim 9, wherein the immersing the piece of wood in the solution comprises, exposing the piece of wood to a pressure higher than that of a surrounding atmospheric pressure.

15. The method of claim 9, wherein the immersing the piece of wood in the solution comprises, exposing the piece of wood to a pressure lower than that of a surrounding atmospheric pressure.

16. The method of claim 9, wherein the piece of wood comprises a piece of pedunculated oak.
